(19) United States
(12) Patent Application Publication
(10) Pub. No.: US 2005/0012013 A1
(43) Pub. Date: Jan. 20, 2005

(54) Pair of seat rails for a vehicle seat

(75) Inventors: Thomas Dill, Kaiserslautern (DE); Dieter Braun, Otterberg (DE); Joachim Muhlberger, Obersulzen (DE); Ingo Teufel, Rockenhausen (DE); Stefan Roth, Kaiserslautern (DE)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: KEIPER GmbH & Co. KG

(21) Appl. No.: 10/885,832

(22) Filed: Jul. 7, 2004

(30) Foreign Application Priority Data
Jul. 15, 2003 (DE) 103 31 894.1

(51) Int. Cl. F16M 13/00

(52) U.S. Cl. 248/424

(57) ABSTRACT

In a pair of seat rails for a vehicle seat, in particular for an automobile seat, with a first seat rail (1) and a second seat rail (2), with the first seat rail (1) being guided in the longitudinal direction for displacement in the second guide rail (2) and having at least one interlocking section (11) for interacting with the second seat rail (2) and an adapter section (13), which includes at least one mounting point (15) for arranging a structural component of the vehicle seat (5), a hole (21) is provided between the mounting point (15) and the interlocking section (21), and the hole is operative for operating advantageously in the event of a crash.

### BACKGROUND OF THE INVENTION

The present invention relates to a pair of seat rails for a vehicle seat, in particular for an automobile seat, with the pair of seat rails including a first seat rail that is guided in a second seat rail for displacement in the longitudinal direction, and the first seat rail including an adapter section and at least one interlocking section for interacting with the second seat rail, with the adapter section including at least one mounting point for receiving a structural component of the vehicle seat.

In the case of a known pair of seat rails of the type described above, and which is arranged on the side of the vehicle seat with the belt lock, reinforcement is provided, in particular for the second seat rail at the rear end (or in another critical region). This reinforcing prevents, in the event of a crash or in the case of a belt equivalent load test in the foremost position, the first seat rail from cutting off the second rail with its interlocking section as a result of forces that are introduced into the first seat rail via the mounting point.

### BRIEF SUMMARY OF SOME ASPECTS OF THE INVENTION

An aspect of the present invention is the provision of an improvement to the type of seat rails described above, in particular with respect to production costs and weight. In accordance with this aspect, a pair of seat rails for a vehicle seat, in particular for an automobile seat, includes a first seat rail that is guided in a second seat rail for displacement in the longitudinal direction, and the first seat rail includes at least one interlocking section and an adapter section. The interlocking section is for interacting with the second seat rail, and the adapter section includes at least one mounting point for connecting to a structural component of the vehicle seat. Further in accordance with this aspect, a hole is provided between the mounting point and the interlocking section.

During normal use prior to a crash of predetermined magnitude, at least some of the material that extends around and defines the hole is preferably load-bearing (e.g., is under compressive stress due to the weight of upper portions of the vehicle seat and any passenger sitting in the vehicle seat). Although the hole will affect the stress distribution (e.g., the hole will cause a concentration of stress) during normal use prior to any crash, it is preferred for this concentration of stress not to result in any deformation, or for any resulting deformation to be insubstantial, prior to the crash. Therefore, and in this regard, the hole can be characterized as having an insubstantial affect prior to the crash. It is also preferred for the hole to be substantially functionless in other regards prior to any crash. That is, it is preferred for the hole not to be used, except that it functions advantageously in the event of the crash of predetermined magnitude, or the like.

As a result of providing the hole between the mounting point and the interlocking section, the forces that are introduced in the event of a crash via the mounting point are concentrated (e.g., stress is concentrated in at least some of the material that surrounds and defines the hole) and thereby able to affect a purposeful deformation in the region of the hole. This deformation lowers a retransmission of force on this side of the vehicle seat, and thus makes the load distribution more equal between the two sides of the vehicle seat. This effects a reduction of the partial forces that act upon the interlocking section. Weight and cost increasing reinforcements of the second seat rail will then be unnecessary. Furthermore, still some energy will be dissipated in the event of a crash.

In a preferred embodiment, the hole is made in the shape of a slot, which concentrates the deformation at the ends of the slot. Preferably, the hole is straight and elongated in the longitudinal direction, which optimizes the flow of force, and keeps manufacturing simple. This allows accomplishment of a purposeful movement of the material from the center region of the hole transversely to the longitudinal direction of the slot-shaped hole. Preferably, the hole is formed in the adapter section, i.e., in the vicinity of the mounting point, and preferably below same, which provides a better protection of the other sections. In particular, in the case of an asymmetric rail profile, which is also subjected to an asymmetric load, it will be advantageous for the hole to extend transversely to the longitudinal direction only partially through the adapter section. For example, the hole can be provided only in one layer of two abutting layers that together form the adapter section.

A pair of seat rails made in accordance with the present invention is usable for all types of longitudinally adjustable vehicle seats for promoting an improved load distribution. The effect of the hole will, however, be greatest when the structural component arranged in the mounting point is rigidly mounted to the adapter section. An indentation in the rear edge of the first seat rail improves the protection against a cutting into the second seat rail by this relatively sharp-edged and very stiff seat rail end.

It is preferred for the hole to be proximate the rear edge of the first seat rail and for the hole to be shaped in a manner that at least partially defines an advantageous deformation which occurs in the end section of the first seat rail in the event of the crash of predetermined magnitude, or the like. It is preferred for the indentation in the rear edge of the first seat rail to advantageously enhance the deformation which occurs in the end section of the first seat rail as a result of the hole etc.

### BRIEF DESCRIPTION OF THE DRAWINGS

In the following, the invention is described in greater detail with reference to an embodiment illustrated in the drawings, in which:

FIG. 1 is a longitudinal sectional view of the embodiment taken along line I-I of FIG. 2;

FIG. 2 is a cross-sectional view of the embodiment taken along line II-II of FIG. 1; and

FIG. 3 is a schematic view of a vehicle seat.

### DETAILED DESCRIPTION OF THE INVENTION

The present invention now will be described more fully hereinafter with reference to the accompanying drawings, in which one of the embodiments of the invention is shown. Indeed, the invention may be embodied in many different forms and should not be construed as limited to the embodiment(s) set forth herein; rather, these embodiment(s) are provided so that this disclosure will satisfy applicable legal requirements. Like numbers refer to like elements throughout.

A first seat rail 1, which is constructed as an upper rail and used as a slide rail, is arranged in a known manner for displacement in the longitudinal direction in a second seat rail 2, which is constructed as a lower rail and used as a guide rail. The first seat rail 1 preferably carries a locking mechanism (not shown) for engaging at least the second seat rail 2 to releasably lock the seat rails 1 and 2 together and thereby prevent the first seat rail from sliding relative to the second seat rail. For example, suitable locking mechanisms for being carried by the first seat rail 1 and at least engaging the second seat rail 2 to releasably lock the seat rails 1 and 2 together and thereby prevent the first seat rail from sliding relative to the second seat rail are disclosed by U.S. Pat. Nos. 6,648,291 and 6,742,753, and Pat. Pub. No. 2003/0062462, and each of these documents is incorporated herein by reference in its entirety.

The two seat rails 1 and 2 form a pair of seat rails, which is arranged on one side of a vehicle seat 5 and used for a longitudinal adjustment of the vehicle seat 5. The positions, in which the two seat rails 1 and 2 can be releasably locked together, define the possible, longitudinal positions of the seat. The arrangement of the seat rails 1 and 2 defines the herein-used directional terminology. The second seat rail 2 is designed for being secured to the vehicle structure, whereas the first seat rail 1 is connected to the seat structure components of the vehicle seat 5 to become integral with the seat part.

In its lower portion, the first seat rail 1 is approximately U-shaped. The longitudinal edges of the first seat rail 1 serve as interlocking sections 11 that are bent outward and upward and interact by reciprocal engagement with corresponding, inward and downward bent interlocking sections of the second seat rail 2. In its upper portion, the first seat rail 1 includes an upwardly projecting adapter section 13 that is generally in the form of a plate. The first seat rail 1 consists of two longitudinal parts which lie flat against each other and which are joined in the adapter section 13. At the rear end of the first seat rail 1, the adapter section 13 includes a mounting point in the form of a bore 15 for rigidly mounting a seat frame or another rigid component of the seat structure, and a further polygonal mounting point 17 for alternatively pivotably connecting a rocker arm or another movable component of the seat structure.

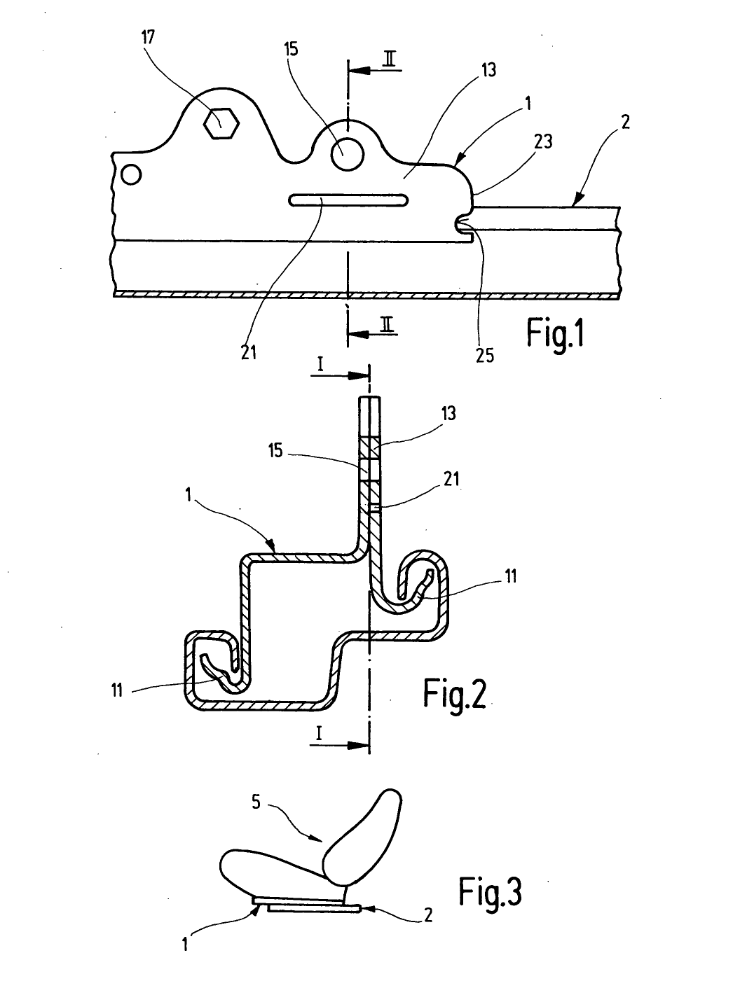

In the adapter section 13, between the mounting point 15 and the interlocking sections 11, more specifically directly below the mounting point 15, a slot-shaped, straight-line hole 21 is formed. The hole 21 extends in the longitudinal direction, i.e., it is horizontally arranged. The hole 21 is preferably elongated, such that its length, which extends in the longitudinal direction, is at least about three times greater than its height. Stated differently, the hole 21 defines a first maximum dimension which extends in the longitudinal direction between surfaces that define the hole, the hole defines a second maximum dimension which extends upright and perpendicular to the longitudinal direction between surfaces that define the hole, and the first maximum dimension is at least about three times larger than the second maximum dimension. Preferably the first maximum dimension is more than three times larger than the second maximum dimension, such as by being at least about four, five, six, seven or more times (e.g., at least about ten times) larger. As illustrated in FIG. 1, the first maximum dimension is about fourteen times larger than the second maximum dimension.

In the present embodiment, the hole 21 extends through the material of one of the two longitudinal parts in the adapter section 13, namely in FIG. 2 the longitudinal part at the right, which is somewhat stiffer than the longitudinal part at the left. In the present embodiment, the center of the hole 21 is located exactly below the mounting point 15, but it may also be differently arranged. In a rear edge 23 of the first seat rail 1, the interlocking section 11 that is closer to the mounting point 15 includes an indentation 25 that opens rearward in the longitudinal direction.

In the event of a crash, for example, a front end crash, or in the case of a static belt equivalent load test, strong forces are introduced via the mounting point 15, in particular on the vehicle seat side with the belt lock. Because of the hole 21, the adapter section 13 undergoes a purposeful plastic deformation in the region of the hole. This deformation temporarily causes a lesser retransmission of force. As a result of transmitting the forces on the one hand between the two longitudinal parts of the first seat rail 1 and on the other hand via the rigid seat frame to the other side of the vehicle seat, a more even distribution of the asymmetrically introduced load occurs within the first seat rail 1 and between two sides of the vehicle seat, i.e., the supporting part of the interlocking and guide sections becomes more even. This lessens the risk that the first seat rail 1 will cut with its interlocking sections 11 on the rear edge 23 into, and possibly through, the second seat rail 2. Furthermore, in the event of a crash, a small portion of the crash energy is dissipated by the plastic deformation. With the purposeful deformation, the rear edge 23 is pulled upward. In this process, the indentation 25 prevents in addition a notch effect of the material portion that downwardly defines the indentation 25, by bending this sharp-edged and stiff material portion downward instead of allowing it to cut into the interlocking section of the second seat rail 2 and to tear the profiled section of the second seat rail 2, which is under a tensile stress.

During normal use prior to the crash, at least some of the material of the adapter section 13 that surrounds and defines the hole 21 is preferably load-bearing (e.g., is under compressive stress due to the weight of upper portions of the vehicle seat 5 and any passenger sitting in the vehicle seat). Although the hole 21 will affect the stress distribution (e.g., the hole will cause a concentration of stress) in the adapter section 13 during normal use prior to any crash, it is preferred for this concentration of stress not to result in any deformation in the adapter section, or for any resulting deformation to be insubstantial, prior to the crash. Therefore, and in this regard, the hole 21 can be characterized as having an insubstantial affect prior to the crash. It is also preferred for the hole to be substantially functionless in other regards prior to any crash. For example, it is preferred for the hole 21 to be substantially functionless prior to any occurrence of the crash or equivalent load test, such as by the hole 21 not being in receipt of a fastener, such as a bolt, and the hole 21 not being for receiving an element of a locking mechanism (e.g., an element of a locking mechanism that is carried by the first seat rail 1 and at least engages the second seat 2 to releasably lock the rails 1 and 2 together), such as a dog, pin, or the like.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A pair of seat rails that are for a vehicle seat and are for operating advantageously in the event of a crash or load testing of a predetermined magnitude, with the pair of seat rails comprising:
a first seat rail that is guided in a second seat rail for displacement in a longitudinal direction, wherein the first seat rail includes:
at least one interlocking section for interacting with the second seat rail,
an adapter section that includes at least one mounting point for being connected to a structural component of the vehicle seat, and
a hole that is in the first seat rail and is positioned between the mounting point and the interlocking section, wherein the hole is:
substantially functionless prior to any occurrence of the crash or load testing of the predetermined magnitude, and
for at least partially affecting deformation of the first seat rail in a predetermined manner in the event of the crash or load testing of the predetermined magnitude.

2. The pair of seat rails according to claim 1, wherein the hole is slot-shaped.

3. The pair of seat rails according to claim 2, wherein the hole is elongated in a straight line.

4. The pair of seat rails according to claim 3, wherein the hole is elongated in the longitudinal direction.

5. The pair of seat rails according to claim 1, wherein the hole is located in the adapter section of the first seat rail.

6. The pair of seat rails according to claim 5, wherein the hole is positioned directly below the mounting point.

7. The pair of seat rails according to claim 5, wherein the hole extends only partially through the adapter section in a direction that is transverse to the longitudinal direction.

8. The pair of seat rails according to claim 1, wherein the structural component of the vehicle seat is rigidly mounted to the adapter section.

9. The pair of seat rails according to claim 1, wherein an indentation is defined by a rear edge of the first seat rail for at least partially affecting the deformation of the first seat rail in the event of the crash or load testing of the predetermined magnitude.

10. The pair of seat rails according to claim 1, wherein with respect to one another the first seal rail is an upper rail and the second seat rail is a lower rail.

11. The pair of seat rails according to claim 1 in combination with the vehicle seat, so that the vehicle seat is longitudinally adjustable.

12. The pair of seat rails according to claim 1, wherein the hole remains open at least prior to any occurrence of the crash or load testing of the predetermined magnitude.

13. The pair of seat rails according to claim 1, wherein at least prior to any occurrence of the crash or load testing of the predetermined magnitude, the hole is not in receipt of an obstruction.

14. The pair of seat rails according to claim 1, wherein:
the hole defines a first maximum dimension which extends in the longitudinal direction between surfaces that define the hole,
the hole defines a second maximum dimension which extends upright and perpendicular to the longitudinal direction between surfaces that define the hole, and
the first maximum dimension is at least about three times larger than the second maximum dimension.

15. The pair of seat rails according to claim 1, wherein the hole extends only partially through the first seat rail.

16. The pair of seat rails according to claim 1, wherein the hole is a first hole, the mounting point comprises a second hole, and at least a portion of the first hole is positioned rearward of the second hole.

17. The pair of seat rails according to claim 10, wherein the hole is positioned above the lower seat rail.

18. A pair of seat rails that are for a vehicle seat and are for operating advantageously in the event of a crash or load testing of a predetermined magnitude, with the pair of seat rails comprising:
a first seat rail that is guided in a second seat rail for displacement in a longitudinal direction, wherein the first seat rail includes:
at least one interlocking section for interacting with the second seat rail,
an adapter section that includes at least one mounting point for being connected to a structural component of the vehicle seat, and
a hole that is in the first seat rail and is for at least partially affecting deformation of the first seat rail in a predetermined manner in the event of the crash or load testing of the predetermined magnitude, wherein the hole is positioned between the mounting point and the interlocking section, and the hole extends only partially through the first seat rail.

19. The pair of seat rails according to claim 18, wherein:
the hole defines a first maximum dimension which extends in the longitudinal direction between surfaces that define the hole,
the hole defines a second maximum dimension which extends vertically and perpendicular to the longitudinal direction between surfaces that define the hole, and
the first maximum dimension is larger than the second maximum dimension.

20. A method for a pair of seat rails that are for a vehicle seat and are for operating advantageously in the event of a crash or load testing of a predetermined magnitude, the method comprising:
providing the pair of seat rails so that the pair of seat rails includes a first seat rail that is guided in a second seat rail for displacement in a longitudinal direction, and the first seat rail includes:
at least one interlocking section for interacting with the second seat rail,
an adapter section that includes at least one mounting point for being connected to a structural component of the vehicle seat, and
a hole that is in the first seat rail and is positioned between the mounting point and the interlocking section, wherein the hole is operative for at least partially affecting deformation of the first seat rail in a predetermined manner in the event of the crash or load testing of the predetermined magnitude; and
refraining from substantially using the hole prior to any occurrence of the crash or load testing of the predetermined magnitude.

21. The method according to claim 20, wherein the refraining includes keeping the hole open at least prior to the crash or load testing of the predetermined magnitude.
